(19) United States
(12) Patent Application Publication
(10) Pub. No.: US 2019/0179523 A1
(43) Pub. Date: Jun. 13, 2019

(54) Possibility Frontier Visualization in Health Plan Administration

(71) Applicant: William A. Woolston, New Haven, CT (US)

(72) Inventor: William A. Woolston, New Haven, CT (US)

(21) Appl. No.: 15/841,279

(22) Filed: Dec. 13, 2017

(51) Int. Cl. G06F 3/0484; G06Q 40/08

(52) U.S. Cl. CPC G06F 3/04847; G06T 11/206; G06Q 40/08

(57) ABSTRACT

The present invention offers a method and system for health plan administrators and managers of “at risk” provider systems to compare various health plan scenarios and to readily visualize the trade-offs between quality, costs, and potentially, other variables such as total enrollment. The method for visualization utilizes a novel application of the economic concept of production possibility frontiers comprising a graphical user interface using a non-linear slider technique and an underlying database connected with a computer having novel algorithms for data analysis.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Rising healthcare costs without associated rise in quality of service has been an area of concern for many years in the United States. Statistics show the U.S. costs are higher than in many developed countries and that the quality is lower. One approach has been to move towards managed care. Providers of managed care plans have developed a plethora of plans with various payment options and various models for access to health care providers. As a result, the consumer as well as plan administrators have an overwhelming number of choices and for each plan there are trade-offs in costs, quality care and convenience.

Colley, et al. in U.S. Pat. No. 7,912,739 (assigned to Dominion Ventures) discloses a method for health plan management that includes the use of theoretically derived mathematical models. The methods may be used in the analysis of health insurance products assisting in the selection of a particular health plan's benefit and contribution strategy as well as in the selection of a health plan's funding arrangement. However, the method is directed towards the insured rather than towards the developer of the plans.

There is a need for a better way of comparing plans and analyzing trade-offs in developing and administering plans from the insurer's perspective. From the insurer's perspective, there are additional factors to take into account such as health care provider performance, cost, customer satisfaction and outcome which complicate the analysis. Health plans have competing objectives such as: “minimize costs,” “maximize membership,” “improve quality metrics,” “lower costs”. Another issue might be “how should one match patients to PCPs”? Should it be by geography, by cost, by quality care; or, by some combination of all three? Some health plans may be worse than others (in the sense that they are worse along every dimension. Alternate plans, may lie on the “possibility frontier,” wherein tradeoffs between the plans with respect to pairs of factors can be visualized. There is a great need to provide a method to help planners understand the tradeoffs between the proposed plans or policies. One means of doing this is by (i) charting the possibility frontier and (ii) allowing plans to use a “slider” to change the weights on their objectives and visualize the results.

Economists and business analysts have developed a means of taking a data set of values and producing a graph expressing opportunity costs; wherein, the optimal curve is identified as the frontier. Data points that fall outside the frontier are unachievable and those that are inside the frontier are sub-optimal The cost-value points on the frontier represent trade-offs and opportunities that can result from how scarce resources may be allocated in production. In general one can produce either A or B (guns or butter in one scenario) given a set of limited resources (capital, or personnel for example). The concept helps businesses develop optimal production strategies that use resources efficiently and minimize waste. Calculating the production possibility frontier (PPF) of multiple products is possible with Excel or another spreadsheet program (Investopedia, Apr. 13, 2015).

In a non-obvious extension of the PPF concept the present invention discloses a method of computing and visualizing a Possibility Frontier (PFV) for analysis of health care plans.

The PFV presents a novel interface with the data using as an output a graph in which a slider has been incorporated. The slider travel route is coincident with the curve of the frontier as plotted on a two-dimensional graph. The slider button is indicated on the curve and carries a unique message that is dependent upon the location of the button on the frontier line. Slider technology per se as a means of visualizing interation between variable is not new. For example, Wichelman et al. in U.S. Pat. No. 7,779,368 discloses a system and method for showing cost and level of availability and performance and asserts that “conventional slider controls have been found ineffective. Two slider controls simply do not provide enough information as to whether an optimal combination of values has been selected for two parameters.” The present invention provides an alternative method for presenting data to compare outcomes of selecting multi-parameter systems in a considering optimal outcomes given a variety of trade-offs.

Champion et al. in U.S. Pat. No. 7,562,310 discloses a method for a graphical user interface in which values of first and second variables may be simultaneously adjusted using a slider control displayed in a two-dimension region between the axes. The method calculates the effects of the adjustment on a value of a third variable. A graphical component is then used to depict the updated value of the third variable.

Etgen in U.S. Pat. No. 7,716,602 discloses an accessible markup language specified slider control which has been configured for rendering in a content browser.

Trewin in Patent Application 2007/0220448 discloses techniques for choosing a position on a display having a cursor. An exemplary method includes the steps of automatically moving the cursor in a predetermined way during selection mode in response to a first user-initiated action, and, responsive to a second user-initiated action. The method disclosed overcomes the limitation by Rosen in US Patent Publication No. 2005/0216866 that while it teaches that the position, as well as the image, of the user terminal's curser may be controlled by a remote server, it does not teach any method of target acquisition.

None of the prior art provides a means of adapting the methods to provide a means of dynamically visualizing a performance frontier in combination with a visual display of information at key points along the created curve. Furthermore, none of them combine in such as way as to more easily compare the merits of particular health care plans with respect to quality, value, availability and cost.

### BRIEF SUMMARY OF PREFERRED EMBODIMENTS

In a preferred embodiment, the method provides visual representations of the answers to questions raised in the following scenario:
Consider a health Insurance Plan with 100 HCP (health care providers) in a metropolitan area. Can one increase the value, quality or lower the cost if one eliminates a doctor who is performing poorly along the dimensions that matter to a health plan? What would be the impact on the plan participants who use that doctor? What options do they have? Would they move to another provider who is even lower quality? Or more expensive? What are the trade-offs? If one runs a simulation to assess the trade-offs, how can one best visualize the implications of each option?

The method developed is to employ the concept of the Possibility Frontier in combination with novel computational tools which provide associated displays of data and information to enhance the visualization output. The Possibility Frontier Visualization (PFV) enables policy makers to consider quality (“*” ratings) and savings per enrollee ($), holding fixed other plan objectives (such as number of members). Policies that are better are displayed on the graph to the “northwest” of policies that are worse. See FIG. 3.

A solid line shows the possibilities at the frontier. When considering “optimal” matches between patients and Primary Care Providers (PCPs) for example, the frontier represents the best set of policies or plans. At the frontier, there is a tradeoff between savings and quality.

The shape of the solid black line shows this tradeoff. At portions of the line where the curve may be close to horizontal (say, at the top left of the curve), getting a bit more of savings involves only small costs to quality. At portions of the line where the curve is steep (say, at the bottom right), getting a bit more savings involves a large hit to quality. In a second embodiment, a linear slider is also provided which works in tandem with the non-linear one that tracks the frontier line.

Note that there are millions of possible ways to match patients to PCPs. This “frontier” shows the tradeoff between Quality “*” and $ for the (tiny) subset of matches that are “on the frontier.”

The method and system disclosed provides the user interface and visualization for a system that aggregates data from a variety of sources (including government data, proprietary data and user data), stores it in various databases and uses proprietary algorithms to compute such factors as risk factors, quality assessments, values, costs and availability.

### BRIEF DESCRIPTION OF THE DRAWINGS

The foregoing and other aspects of these teachings are made more evident in the following detailed description when read in conjunction with the attached Figures and as spelled out in the Claims.

FIG. 1 provides an overview of a health plan optimization program.

FIG. 2 depicts a comparison between one embodiment of the present two dimensional non-linear slider invention (2A) and the prior art use (2B) of one dimensional sliders.

FIG. 3 depicts the Graphical User Interface (GUI) for the Possibilities Frontier Visualization (PFV) with two scenarios of non-linear sliders having pop-up boxes.

FIG. 4 depicts the PFV logic flow.

FIG. 5 depicts additional details of the interactive graph formation in the Possibilities Frontier Visualization (PFV).

### DETAILED DESCRIPTION OF THE INVENTION

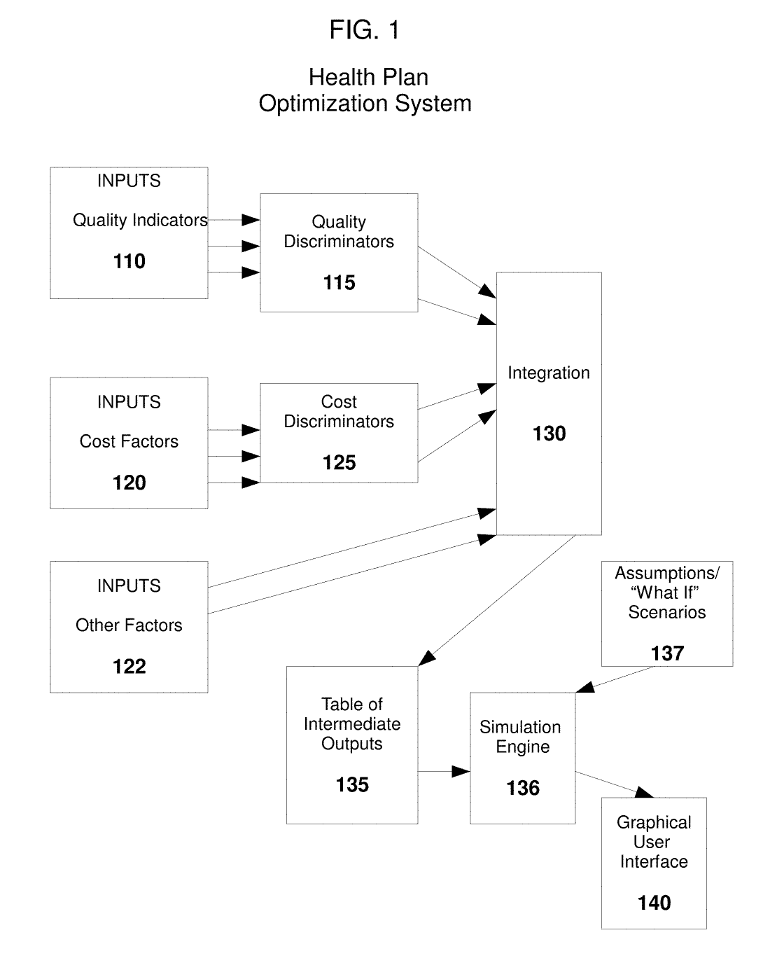

FIG. 1 provides an overview of a health plan optimization program. The program is comprised of Inputs of Quality Indicators (110), Cost Factors (120) and Other Factors (122) that might include for example an assessment of Value. These factors are then subject to ranking or other discriminators for Quality (115) or Cost (125) which are then available for integration (130) processes to produce a Table of intermediate outputs (135). A simulation Engine (136) accepts Queries from a Plan Administrator pursuing “What if” Scenarios (137) and provides an output in the form of a Graphic User Interface (140).

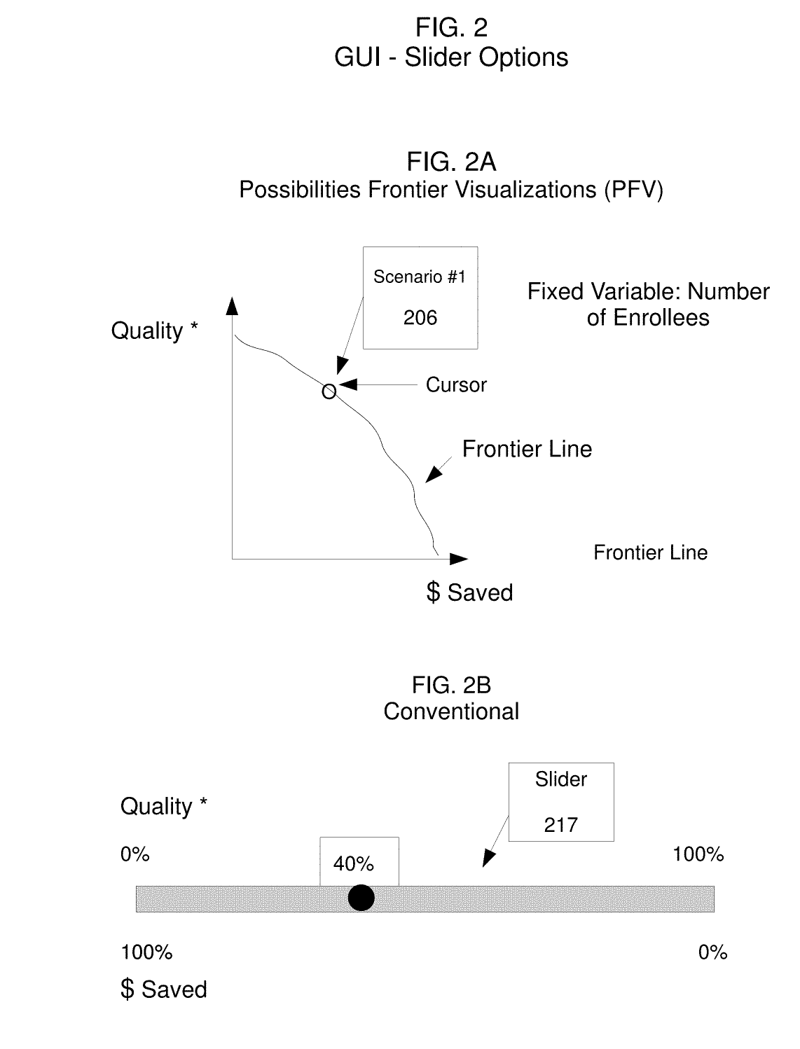

FIG. 2 depicts a comparison between one embodiment of the present invention (2A) and the prior art use of a one-dimensional slider (FIG. 2B). FIG. 2A depicts a two-dimensional non-linear slider in which the Possibility Frontier is indicated on the curved line. In this instance, the cursor (the small open circle) is “landed on” a point on that curve described as the result of Scenario #1 (206). If the cursor is inside the curve, the trade-off between Quality “*” and $ Saved is not optimal. If the cursor is off the curve to the right and/or above the Frontier line it is indeterminate.

The Possibility Frontier Visualization (PFV) enables policy makers to consider quality (* ratings) and savings per enrollee ($), holding fixed other plan objectives (such as number of members (enrollees) as indicated in this Scenario). Policies that are better are displayed on the graph to the “northwest” of the worse policies.

By moving the slider back and forth, users can explore this tradeoff further. In FIG. 2b such a linear slider (217) is illustrated. The position of the slider indicated by the black circle is at the 40% level for the Quality metric. This would coincide with 60% on the money Saved scale indicated below the line.

In one embodiment of the invention a conventional one-dimensional linear slider as depicted in FIG. 2B may be used in conjunction with the non-linear two-dimensional slider of the FIG. 2A. This would offer a convenient way of exploring multiple parameters in a search for the best combination among the many possibilities in an optimization model.

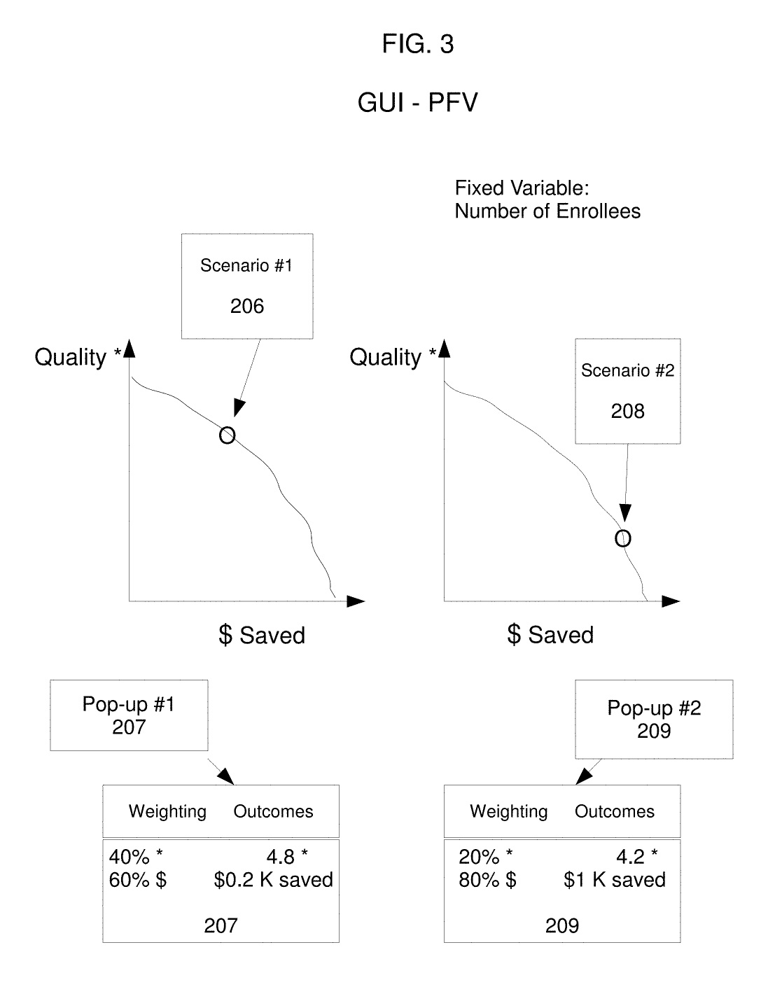

FIG. 3 depicts the Graphical User Interface (GUI) for the Possibilities Frontier Visualization (PFV) interface. Two scenarios of non-linear sliders having pop-up boxes are highlighted corresponding to two points on the frontier curves. Scenario #1 (206) on the left places the cursor somewhat to the “northwest” in which the plan administrator selects a 40% weight on Quality (*) and 60% weight on Dollars Saved. In Scenario #2 (208) on the right, the cursor is placed somewhat to the “southeast” in which the plan administrator considers the impact of a 20% weight on Quality (*) and 80% weight on Dollars Saved.

In one embodiment of the invention there are pop-up tables for each scenario in which the callouts show how changing the weights changes the actual outcomes. A pop-up for Scenario #1 (207) for example provides the outcomes for weightings of 40% for Quality (*) and 60% for Money Saved. Similarly, for the pop-up table (209) for Scenario #2. Namely, it provides the outcomes for weightings of 20% for Quality (*) and 80% for Money Saved. The plan developer/administrator can adjust the inputs of a large number of variables and quickly see the implications.

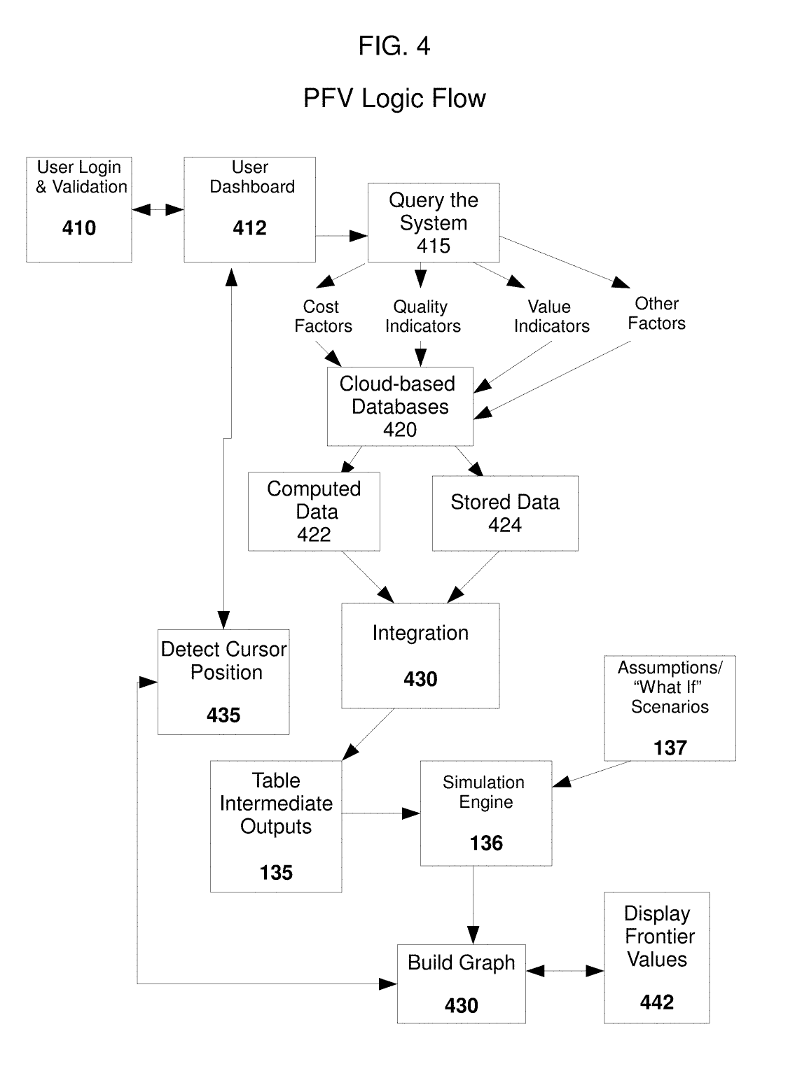

FIG. 4 depicts one embodiment of the logic flow for the Possibility Frontier Visualization (PFV) interface. In a typical implementation, the user logs into their account on the system (410). Once their identity is validated, they are presented with a dashboard (412) presenting them with a number of options. A mouse or other means of navigating and selecting items on the computer screen (such screen may be on any display device including that on a smartphone) is used. In the present embodiment, it is assumed that the user is using a mouse and is moving a cursor that is displayed on the screen. Using such a device, in conjunction with a keyboard, queries are made to the plan optimization system (415). The query may invoke cost factors, quality indicators, value indicators or other factors some of which are extracted from data stored in cloud-based databases (420) and others are determined through calculations made in real time (422). This stream of data is then organized and integrated (431) into presenting an intermediate table of output values (135) that are presented to a simulation engine (136). The simulation engine also receives inputs from a user who has developed a number of “what if” scenarios to test (137). The simulation engine (136) uses these inputs to build a graph (430) and to display values (442). The graph building component (430) also receives input on the position of the cursor (435) that moves in response to the user's control.

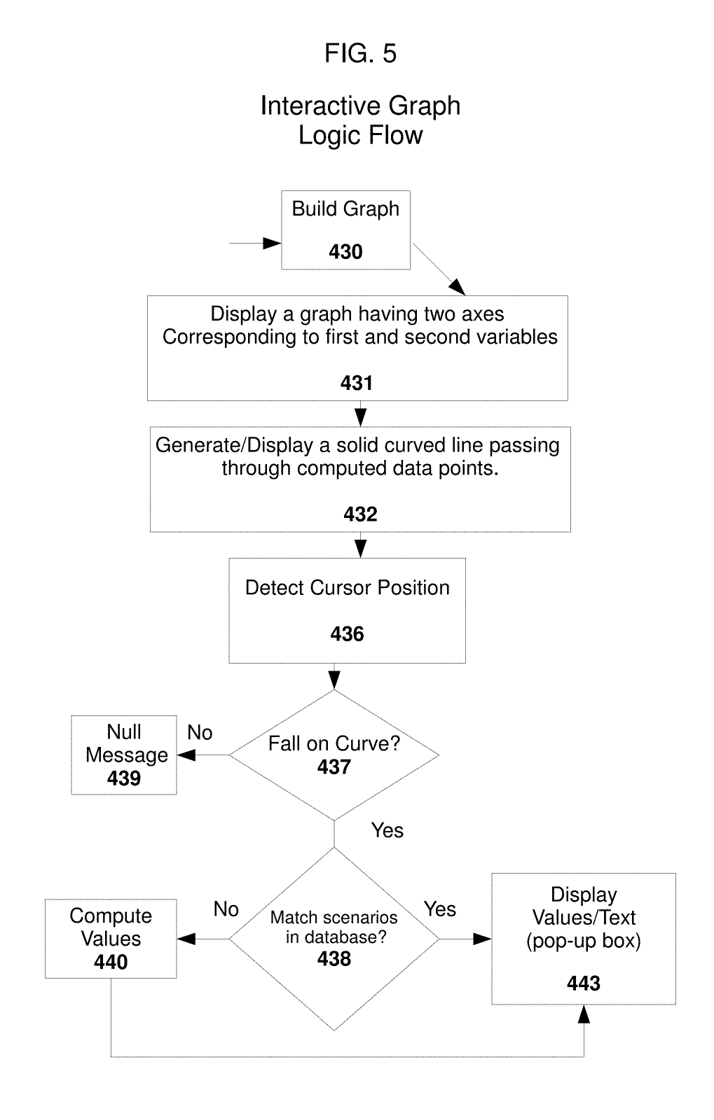

FIG. 5 provides further details of the graph formation module (430) in the PFV interface. The first step is to generate and display on the screen a graph having at least two axes that correspond to the first and second variables under consideration. Third, fourth or n^{th} variables are held constant for any given scenario. However, there is no restriction on which variables may be selected as the two that are varied.

Data point pairs are generated by the system that represent values for particular points on the frontier curve. A line is then displayed which passes through these points (432). Various curve fitting algorithms that are known in the art may be employed.

One novel feature of the present invention is a method that detects the cursor position (436) and detects whether it falls on the optimal frontier line (437). If it doesn't, then a Null message (439) may be displayed on the screen such as “the data point is sub-optimal” if below the line or “the data point is indeterminate” if the cursor position is above the line.

If the cursor falls on the frontier curve, then a check is made to see whether there are comparable scenarios stored in a database (438) sufficient provide values and textual information in a pop-up box (443). If there is no match with stored scenarios, then the system may compute values (440) data suitable to display in a pop-up box (443) or similar visualization of a table of text and values.

The foregoing summary of the embodiments of the present invention is exemplary and non-limiting. For example, one skilled in the art will understand that one or more aspects or steps from one embodiment can be combined with one or more aspects or steps from another embodiment to create a new embodiment within the scope of the present invention.

What is claimed is:

1. A computer-implemented method of comparing different scenarios in a health care planning application comprised of creating an interactive graphical user interface comprised of a means to produce a two dimensional graphical display that links a user operated cursor to a back-end program that generates data points and displays a curve that passes through such data points and which further shows the position of the cursor on the curve and associates numerical data and/or a text message appropriate for the said position. The said displayed curve represents the possibilities frontier for a set of selected pairs of variables such as quality, cost, money saved and value.

2. The method of claim 1 wherein the display of a curve passing through data points and representing the frontier curve may be generated using various curve fitting algorithms known in the art.

3. The method of claim 1 wherein a means is provided to detect whether the cursor falls on the optimal frontier line; and, if it does not, then a null message may be displayed on the screen such as for example “the data point is sub-optimal” if below the line or “the data point is indeterminate” if the cursor position is above the line; and, if the cursor falls on the frontier curve, then a check is made to see whether there are comparable scenarios stored in a database sufficient to provide values and textual information in a pop-up box; and, if there is no match with stored scenarios, then the system may compute values of data through a series of steps involving data integration and a simulation engine suitable to display in a pop-up box.

4. The method of claim 3 wherein a matching algorithm is used to check whether a present scenario matches a stored scenario.

5. The method of claim 1 that is further comprised of a display of one or more single dimension sliders that displays the relative trade-off desired between two mutually competitive variables such as quality versus cost on scales of “0” to 100% for each; wherein the user can move, using a cursor, an indicator on the slide bar to select whether they want to determine for example the impact that lowering the quality would have on cost savings.

6. The method of claim 1 that has the additional feature of displaying a table that displays an output from a database and processing system that enables the running of “what if” scenarios and provides a table indicating the outcomes of selecting different weighting factors expressed as percentages. The displayed table may appear as a pop-up box upon hovering over a point on the aforenamed curve or may be presented as a stable image upon clicking on said point on the curve.

7. The method of claim 6 wherein the weighting factors for example might be expressed as a percentage of “0” to 100% for one variable and another percentage for a second variable wherein the percentages of the two sum to 100%. The data for such tables are generated by the over-all system but displayed under user control via a cursor in the graphical user interface.

8. A computer memory medium tangibly embodying a program of machine-readable instructions executable by a digital processing apparatus comprised of a query system to select cost factors, quality indicators and value indicators from cloud-based databases to to produce a two dimensional graphical display that links a user operated cursor to a program that generates data points and displays a curve that passes through such data points and which further shows the position of the cursor on the curve and associates numerical data and/or a text message appropriate for the said position. The said displayed curve represents the possibilities frontier for a set of selected pairs of variables such as quality, cost, money saved and value.

9. The computer medium of claim 8 wherein a means is provided to detect whether the cursor falls on the optimal frontier line; and, if it doesn't, then a null message may be displayed on the screen such as for example “the data point is sub-optimal” if below the line or “the data point is indeterminant” if the cursor position is above the line; and, if the cursor falls on the frontier curve, then a check is made to see whether there are comparable scenarios stored in a database sufficient to provide values and textual information in a pop-up box; and, if there is no match with stored scenarios, then the system may compute values of data through a series of steps involving data integration and a simulation engine suitable to display in a pop-up box.

10. The computer medium of claim 8 that is further comprised of a display of one or more single dimension sliders that displays the relative trade-off desired between two mutually competitive variables such as quality versus cost on scales of “0” to 100% for each; wherein the user can move with a cursor an indicator on the slide bar to select whether they want to determine for example the impact that lowering the quality would have on cost savings.

11. The computer medium of claim 8 that has the additional feature of displaying a table that displays an output from a database and processing system that enables the running of “what if” scenarios and provides a table indicating the outcomes of selecting different weighting factors expressed as percentages. The displayed table may appear as a pop-up box upon hovering over a point on the aforenamed curve or may be presented as a stable image upon clicking on said point on the curve.

12. A system comprised of at least one cloud-based database comprised of health care related data and at least one query system and associated computer programs to determine the impact of changing various health care factors and a means for creating “what-if” scenarios and displaying the outcomes on a two dimensional display that graphically provides a means for a user to interact with the display elements as presented on a Possibility Frontier curve. Such system includes a cursor display code module, stored in a computer readable medium.

13. A system as in claim 12 that provides a means of comparing different scenarios in a health care planning application comprised of creating an interactive graphical user interface comprised of a means to produce a two dimensional graphical display that links a user operated cursor to an active program that generates data points and displays a curve that passes through such data points and which further shows the position of the cursor on the curve and associates numerical data and/or a text message appropriate for the said position. The said displayed curve represents the possibilities frontier for a set of selected pairs of variables such as quality, cost, money saved and value.

14. The system of claim 12 wherein display of a curve passing through data points and representing the frontier curve may be generated using various curve fitting algorithms known in the art.

15. The system of claim 12 wherein a means is provided to detect whether the cursor falls on the optimal frontier line; and, if it doesn't, then a null message may be displayed on the screen such as for example “the data point is sub-optimal” if below the line or “the data point is indeterminant” if the cursor position is above the line; and, if the cursor falls on the frontier curve, then a check is made to see whether there are comparable scenarios stored in a database sufficient to provide values and textual information in a pop-up box; and, if there is no match with stored scenarios, then the system may compute values of data through a series of steps involving data integration and a simulation engine suitable to display in a pop-up box.

16. The system of claim 12 wherein a matching algorithm is used to check a present scenario with a stored scenario.

17. The system of claim 12 that is further comprised of a display of one or more single dimension sliders that displays the relative trade-off desired between two mutually competitive variables such as quality vs. cost on scales of “0” to 100% for each; wherein the user can move with a cursor an indicator on the slide bar to select whether they want to determine for example the impact that lowering the quality would have on cost savings.

18. The system of claim 12 that has the additional feature of displaying a table that displays an output from a database and processing system that enables the running of “what if” scenarios and provides a table indicating the outcomes of selecting different weighting factors expressed as percentages.

19. The displayed table of claim 18 may appear as a pop-up box upon hovering over a point on the aforenamed curve or may be presented as a stable image upon clicking on said point on the curve.

20. The system of claim 12 wherein the weighting factors for example might be expressed as a percentage of “0” to 100% for one variable and another percentage for a second variable wherein the percentages of the two sum to 100%. The data for such tables are generated by the over-all system but displayed under user control via a cursor in the graphical user interface.
